(19) United States
(12) Patent Application Publication
(10) Pub. No.: US 2020/0088857 A1
(43) Pub. Date: Mar. 19, 2020

(54) SENSOR ASSEMBLY WITH COMPREHENSIVE SYSTEM TO REMOVE DEBRIS AND PREVENT OBSTRUCTIONS

(71) Applicant: FORD GLOBAL TECHNOLOGIES, LLC, Dearborn, MI (US)

(72) Inventor: Ira Jason Goldberg, Ann Arbor, MI (US)

(21) Appl. No.: 16/131,947

(22) Filed: Sep. 14, 2018

(51) Int. Cl. G01S 7/497; G01D 11/24; G01S 7/481; G01S 17/93

(52) U.S. Cl. CPC G01S 7/497; G01D 11/245; G01S 2007/4977; G01S 17/936; G01S 7/4813

(57) ABSTRACT

A sensor assembly includes a sensor module, a cover over the sensor module and an air jet feature. The air jet feature operates in conjunction with a heating element and a liquid fluid washing feature to efficiently and effectively clear fluid and debris from the cover to allow the most efficient and effective operation of the sensor module. A related method of preventing sensor obstructions is also disclosed.

### TECHNICAL FIELD

This document relates generally to the motor vehicle equipment field and, more particularly, to a new and improved sensor assembly incorporating a comprehensive system to remove debris and prevent obstructions that might otherwise impair proper operation.

### BACKGROUND

In an effort to improve the safety of motor vehicles, many manufacturers have implemented sensor systems to help the vehicle “see” its surrounding environment. These sensor systems have been used to (a) indicate potential obstacles to the driver, (2) regulate the speed and (3) regulate the follow distance of the motor vehicle while operating in cruise control and enable full autonomy, amongst other uses.

As motor vehicles become more reliant on these sensor systems, it becomes imperative that the sensor modules sensor of the systems remain free of debris that might impair their proper operation. On vehicles today, a common problem is that snow and ice buildup may obstruct the view of a sensor module, effectively rendering that sensor module inoperative.

In the case of autonomous vehicles reliant on sensor-based systems for proper operation, this can lead to the vehicle being inoperable until the obstruction (accumulated ice and snow for example) is manually cleared. Such a scenario is less than ideal, especially in cases where the autonomous vehicle is being operated as a transportation as a service (Taas) vehicle. More specifically, it can lead to stranded passengers and extensive down time.

This document relates to a new and improved sensor assembly incorporating a comprehensive system of features adapted to maintain the sensor assembly free and clear of debris and other obstructions that might otherwise hinder proper operation of the sensor module(s) of the sensor assembly.

### SUMMARY

In accordance with the purposes and benefits as described herein, a new and improved sensor assembly is provided. That sensor assembly comprises a sensor module, a cover over the sensor module and an air jet feature to clear fluid and debris from the cover and thereby maintain efficient and effective operation of the sensor assembly.

The sensor assembly may further include a heating element to heat the cover and thereby melt ice and snow during winter weather conditions. More particularly, the cover may include a sensor zone and the heating element may outline that sensor zone.

Still further, the sensor system may further include a liquid fluid washing feature. That liquid fluid washing feature may include a liquid fluid reservoir, a liquid fluid nozzle oriented toward the cover and a liquid fluid pump that pumps liquid fluid from the liquid fluid reservoir to the liquid fluid nozzle whereby liquid fluid is sprayed over the sensor zone to wash dirt and debris away from the sensor zone.

The air jet feature may comprise an air pump and an air jet nozzle oriented toward the cover whereby an air jet is generated and directed over the sensor zone. In this way it is possible to blow liquid fluid, including cleaning fluid, away from the sensor zone of the cover and thereby allow for the most efficient and effective operation of the sensor module.

The sensor assembly may further include a control module configured to control operation of the heating element, the liquid fluid pump and the air pump. The control module may be adapted or configured to ensure the most efficient and effective cleaning of the cover including, particularly the sensor zone of the cover through which the sensor module detects the environment around the motor vehicle to which the sensor assembly is associated.

In accordance with yet another aspect, a new and improved method is provided of preventing sensor obstructions. That method comprises directing, by an air jet feature, an air jet across a cover of a sensor module and cleaning debris from that cover.

The method may further include the step of heating, by a heating element, the cover to melt any ice and snow during winter weather conditions. Further, the method may include the step of washing, by a liquid fluid washing feature, dirt and debris from the cover.

Still further, the method may include directing, by the liquid fluid washing feature, a stream of liquid fluid over the cover and then cleaning the liquid fluid from the cover by the air jet.

In the following description, there are shown and described several preferred embodiments of the sensor assembly as well as the related method of preventing sensor module obstructions. As it should be realized, the sensor assembly and related method are capable of other, different embodiments and their several details are capable of modification in various, obvious aspects all without departing from the sensor assembly and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the sensor assembly and method and together with the description serve to explain certain principles thereof.

FIG. 1A is a schematic side elevational view of the sensor assembly showing the sensor module, the cover over the sensor module, the heating element outlining the sensor zone of the cover as well as the liquid fluid nozzle and the air jet nozzle oriented toward the cover and, more particularly, the sensor zone of the cover.

FIG. 1B is a front elevational view of the sensor assembly illustrated in FIG. 1A.

FIG. 2 is a schematic block diagram of the electronic control system and debris cleaning features of the sensor assembly illustrated in FIGS. 1A and 1B.

Reference will now be made in detail to the present preferred embodiments of the sensor assembly as well as to the related method of preventing sensor obstructions, examples of which are illustrated in the accompanying drawing figures.

### DETAILED DESCRIPTION

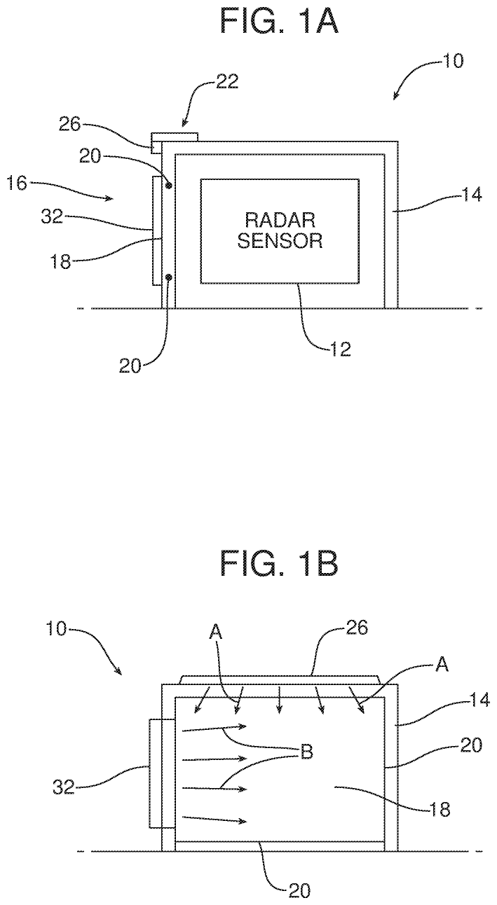

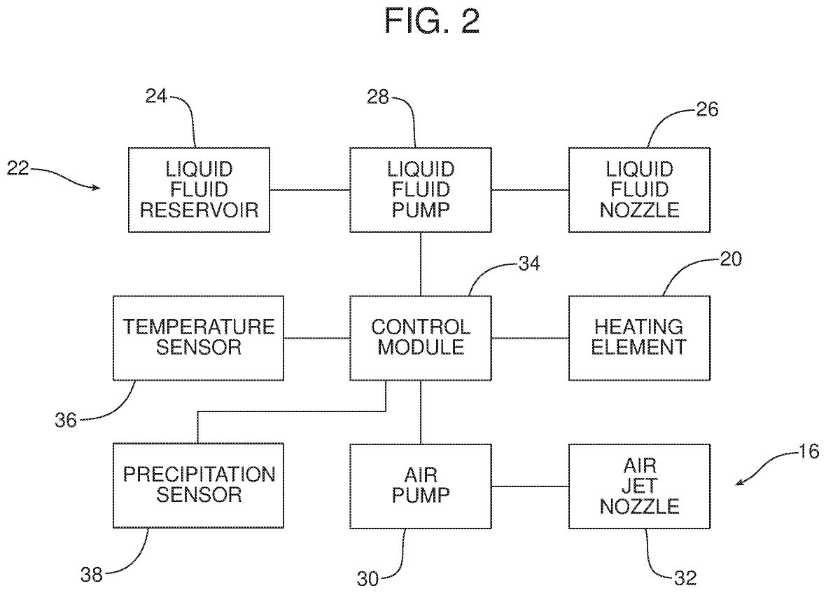

Reference is now made to FIGS. 1A, 1B and 2 illustrating the new and improved sensor assembly 10 which incorporates a comprehensive system of features for cleaning dirt, debris and obstructions from the sensor assembly to thereby maintain efficient and effective operation thereof. As illustrated, the sensor assembly 10 includes a sensor module 12, a cover 14 over the sensor module and an air jet feature, generally designated by reference numeral 16, to clear fluid and debris from the cover.

More particularly, the sensor module 12 may comprise any type of sensor module known in the art to be useful for improving the safety or providing autonomous or semi-autonomous operation of the motor vehicle to which the sensor assembly is associated. Thus, the sensor module 12 may comprise, but is not necessarily limited to a sensor module, a lidar module, an imaging module, a camera module or combinations thereof.

The cover 14 may be made from any appropriate material suitable for its intended purpose of protecting the sensor module 12 from moisture, dirt and debris. As should be appreciated, the cover 14 includes a sensor zone 18 through which the sensor module 12 “sees” the environment around the motor vehicle to which the sensor assembly 10 is associated. Typically, at least the sensor zone 18 of the cover 14 is made from a constant thickness dielectric material (such as plastic).

The sensor assembly 10 may also include a heating element 20 adapted or configured to heat the cover 14 and thereby prevent the buildup of ice and snow, particularly in the area of the sensor zone 18 during winter weather conditions. In the illustrated embodiment, the heating element 20 comprises a resistance heating element that outlines the sensor zone 18.

Still further, the sensor assembly 10 also includes a liquid fluid washing feature 22. More particularly, the liquid fluid washing feature 22 includes a liquid fluid reservoir 24, a liquid fluid nozzle 26 oriented toward the cover 14 and, more particularly, the sensor zone 18 of the cover, and a liquid fluid pump 28 (see FIG. 2). Liquid fluid, such as cleaning fluid, retained in the reservoir 24 is pumped by the liquid fluid pump 28 and sprayed from the liquid fluid nozzle 26 across the cover 14 and, more particularly, the sensor zone 18, in order to wash dirt and debris from the sensor zone and thereby improve the operating efficiency of the sensor module 12.

The air jet feature 16 comprises an air pump 30 and a cooperating air jet nozzle 32 oriented toward the cover 14 and, more particularly, the sensor zone 18 of the cover. As should be appreciated, the air jet feature 16 generates an air jet that is directed over the sensor zone 18 to sweep dirt and debris including particularly, the liquid fluid from the liquid fluid washing feature 22, from the sensor zone.

As illustrated in FIG. 2, the sensor assembly 10 may further include a control module 34. The control module 34 may comprise a computing device such as a dedicated microprocessor or an electronic control unit (ECU) operating in accordance with instructions from appropriate control software. Thus, the control module 34 may comprise one or more processors, one or more memories and one or more network interfaces all in communication with each other over one or more communication buses. In the illustrated embodiment, the control module 34 is configured or adapted to control operation of the heating element 20, the liquid fluid pump 28 and the air pump 30 in order to provide a coordination between the various cleaning features 16, 20, 22 of the sensor assembly and thereby maximize their cleaning efficiency.

A new and improved method of preventing sensor obstructions is also provided. That method may be described as broadly comprising directing, by the air jet feature 16, an air jet across a cover 14 of a sensor module 12 and clearing debris from that cover. The method may include the step of heating, by the heating element 20, the cover 14 to melt any ice and snow. Further, the method may include the step of washing, by the liquid fluid washing feature 22, dirt and debris from the cover 14. Still further, the method may include directing, by the liquid fluid washing feature 22, a stream of liquid fluid over the cover 14 and then clearing the liquid fluid from the cover by the air jet.

Operation of the various cleaning features 16, 20, 22 may be coordinated by the control module 34 in order to enhance their effectiveness in cleaning dirt and debris from the cover 14 and, more particularly, the sensor zone 18, of the sensor assembly 10. More particularly, the control module 34 may be adapted to receive ambient temperature data from a temperature sensor 36 and precipitation data from a precipitation sensor 38. When the temperature sensor data and precipitation data suggests the potential for accumulation of ice and snow on the cover 14, the control module 34 is configured to activate the heating element 20 to heat the cover 14 and thereby melt ice and snow at least from the sensor zone 18. The control module 34 may be configured to periodically activate the liquid fluid washing feature 22 causing the liquid fluid pump 28 to pump liquid fluid, such as cleaning fluid from the liquid fluid reservoir through the liquid fluid nozzle whereby that liquid fluid is directed to spray across the sensor zone 18 of the cover 14 sweeping dirt and debris from the sensor zone (note action arrows A in FIG. 1B). Here it should be appreciated that the liquid fluid may include an antifreeze agent if desired. At the same time it should be appreciated that the heating element 20 may be maintained in an activated state to prevent any freezing of the liquid fluid sprayed by the liquid fluid washing feature 22 across the sensor zone 18.

Subsequent to the spraying of the liquid fluid through the liquid fluid washing feature 22, the control module 34 may be configured to activate the air jet feature 16 causing the air pump 30 to pump air through the air jet nozzle at high pressure thereby clearing any remaining liquid fluid from the sensor zone 18 of the cover 14 (note action arrows B in FIG. 1B). Thus, it should be appreciated how heat from the heating element 20 is coordinated with liquid fluid from the liquid fluid washing feature 22 and an air jet from the air jet feature 16 to maximize the cleaning of dirt and debris from the sensor zone 18 of the cover 14. This ensures the most efficient and effective operation of the sensor module 12.

The foregoing has been presented for purposes of illustration and description. It is not intended to be exhaustive or to limit the embodiments to the precise form disclosed. Obvious modifications and variations are possible in light of the above teachings. For example, the control module 34 may be adapted to receive image data from a camera or other device (not shown) providing images of the sensor zone 18 of the cover 14. When that image data indicates that the sensor zone 18 has accumulated a particular predetermined level of obstruction from dirt or other material, the control module 34 may be adapted or configured to initiate the process for cleaning that dirt from the sensor zone 18 of the cover 14. All such modifications and variations are within the scope of the appended claims when interpreted in accordance with the breadth to which they are fairly, legally and equitably entitled.

What is claimed:

1. A sensor assembly, comprising:
a sensor module;
a cover over said sensor module; and
an air jet feature to clear fluid and debris from said cover.

2. The sensor assembly of claim 1, further including a heating element to heat said cover.

3. The sensor assembly of claim 2, wherein said cover includes a sensor zone and said heating element outlines said sensor zone.

4. The sensor assembly of claim 3, further including a liquid fluid washing feature.

5. The sensor assembly of claim 4, wherein said liquid fluid washing feature includes a liquid fluid reservoir, a liquid fluid nozzle oriented toward said cover and a liquid fluid pump pumping liquid fluid from said liquid fluid reservoir to said liquid fluid nozzle whereby liquid fluid is sprayed over said sensor zone.

6. The sensor assembly of claim 5, wherein said air jet feature comprises an air pump and an air jet nozzle oriented toward said cover whereby an air jet is generated and directed over said sensor zone.

7. The sensor assembly of claim 1, wherein said air jet feature comprises an air pump and an air jet nozzle oriented toward said cover whereby an air jet is generated and directed over said cover.

8. The sensor assembly of claim 2, wherein said air jet feature comprises an air pump and an air jet nozzle oriented toward said cover whereby an air jet is generated and directed over said cover.

9. The sensor assembly of claim 1, further including a liquid fluid washing feature.

10. The sensor assembly of claim 9, wherein said liquid fluid washing feature includes a liquid fluid reservoir, a liquid fluid nozzle oriented toward said cover and a liquid fluid pump pumping liquid fluid from said liquid fluid reservoir to said liquid fluid nozzle whereby liquid fluid is sprayed over said cover.

11. The sensor assembly of claim 10, wherein said air jet feature comprises an air pump and an air jet nozzle oriented toward said cover whereby an air jet is generated and directed over said cover.

12. The sensor assembly of claim 11, further including a control module configured to control operation of a heating element, said liquid fluid pump and said air pump.

13. A method of preventing sensor obstructions, comprising:
directing, by an air jet feature, an air jet across a cover of a sensor module and clearing debris from said cover.

14. The method of claim 13, including heating, by a heating element, said cover to melt ice and snow.

15. The method of claim 14, including washing, by a liquid fluid washing feature, dirt and debris from said cover.

16. The method of claim 15, including directing, by said liquid fluid washing feature, a stream of liquid fluid over said cover and then clearing said liquid fluid from said cover by said air jet.

17. The method of claim 13, including washing, by a liquid fluid washing feature, dirt and debris from said cover.

18. The method of claim 17, including directing, by said liquid fluid washing feature, a stream of liquid fluid over said cover and then clearing said liquid fluid from said cover by said air jet.
